(19) United States
(12) Patent Application Publication
(10) Pub. No.: US 2022/0394255 A1
(43) Pub. Date: Dec. 8, 2022

(54) METHOD AND DEVICE FOR PERFORMING AN INVERSE TRANSFORM ON TRANSFORM COEFFICIENTS OF A CURRENT BLOCK

(71) Applicants: HYUNDAI MOTOR COMPANY, Seoul (KR); KIA CORPORATION, Seoul (KR); EWHA UNIVERSITY - INDUSTRY COLLABORATION FOUNDATION, Seoul (KR)

(72) Inventors: Je Won Kang, Seoul (KR); Seung Wook Park, Yongin-si (KR); Wha Pyeong Lim, Hwaseong-si (KR)

(73) Assignees: HYUNDAI MOTOR COMPANY, Seoul (KR); KIA CORPORATION, Seoul (KR); EWHA UNIVERSITY - INDUSTRY COLLABORATION FOUNDATION, Seoul (KR)

(21) Appl. No.: 17/767,007

(22) PCT Filed: Oct. 5, 2020
(86) PCT No.: PCT/KR2020/013468

§ 371 Date: Apr. 6, 2022

(30) Foreign Application Priority Data
Oct. 6, 2019 (KR) 10-2019-0123489
Oct. 7, 2019 (KR) 10-2019-0123683
Oct. 5, 2020 (KR) 10-2020-0127884

(51) Int. Cl. H04N 19/12; H04N 19/159; H04N 19/70; H04N 19/61; H04N 19/176

(52) U.S. Cl. CPC H04N 19/12; H04N 19/159; H04N 19/70; H04N 19/61; H04N 19/176

(57) ABSTRACT

A method and an apparatus for performing inverse transform on transform coefficients of a current block are disclosed. The method comprises: decoding, from a sequence parameter set (SPS) level of a bitstream, one or more intra multiple transform selection (MTS) syntax elements that control the MTS of an intra prediction mode and one or more inter MTS syntax elements that control the MTS of an inter prediction mode; determining one or more transform kernels to be used for the inverse transform of the transform coefficients, on the basis of a prediction mode of the current block, the one or more intra MTS syntax elements, and the one or more inter MTS syntax elements; and performing the inverse transform on the transform coefficients by using the determined one or more transform kernels.

### CROSS-REFERENCE TO RELATED APPLICATIONS

This application is a U.S. national stage of International Application No. PCT/KR2020/013468, filed on Oct. 5, 2020, which claims priority to Patent Application No. 10-2019-0123489 filed in Korea on Oct. 6, 2019, Patent Application No. 10-2019-0123683 filed in Korea on Oct. 7, 2019, and Patent Application No. 10-2020-0127884 filed in Korea on Oct. 5, 2020, the entire contents of which are incorporated herein by reference in their entirety.

### BACKGROUND OF THE DISCLOSURE

### (a) Field of the Disclosure

The present disclosure relates to encoding and decoding of video, and more particularly, to a method and an apparatus for further improving efficiency of encoding and decoding by efficiently controlling coding tools related to transform.

### (b) Description of the Related Art

Since the volume of video data typically is larger than that of voice data or still image data, storing or transmitting video data without processing for compression requires a significant amount of hardware resources including memory.

Accordingly, when video data is stored or transmitted, the video data is generally compressed using an encoder so as to be stored or transmitted. Then, a decoder receives the compressed video data and the decoder decompresses and reproduces the video data. Compression techniques for video include H.264/AVC and High Efficiency Video Coding (HEVC), which improves coding efficiency over H.264/AVC by about 40%.

However, for video data, picture size, resolution, and frame rate are gradually increasing. Accordingly. the amount of data to be encoded is also increasing. Thus, a new compression technique having better encoding efficiency and higher image quality than the existing compression technique is required.

### SUMMARY

### (a) Technical Problem Addressed by the Present Disclosure and Technical Advantage

The present disclosure discloses an improved encoding and decoding technology in order to meet these needs. In particular, an aspect of the present disclosure relates to a technology for improving efficiency of decoding/encoding by controlling multiple transform selection (MTS) through a syntax element defined at a higher level.

### (b) Technical Solution

An aspect of the present disclosure provides a method for performing inversely transforming on transform coefficients of a current block. The method comprises decoding one or more intra multiple transform selection (MTS) syntax elements controlling MTS of an intra prediction mode and one or more inter MTS syntax elements controlling MTS of an inter prediction mode from a sequence parameter set (SPS) level of a bitstream. The method further comprises determining one or more transform kernels to be used for inverse transform of the transform coefficients based on a prediction mode of the current block, the one or more intra MTS syntax elements, and the one or more inter MTS syntax elements. The method still further comprises performing inversely transforming on the transform coefficients by using the determined one or more transform kernels.

An aspect of the present disclosure provides a decoding apparatus that comprises a decoder configured to decode one or more intra multiple transform selection (MTS) syntax elements controlling MTS of an intra prediction mode and one or more inter MTS syntax elements controlling MTS of an inter prediction mode from a sequence parameter set (SPS) level of a bitstream. The decoding apparatus further comprises an inverse transformer configured to determine one or more transform kernels to be used for inverse transform of the transform coefficients based on a prediction mode of the current block, the one or more intra MTS syntax elements, and the one or more inter MTS syntax elements. The inverse transformer is also configured to perform inverse transform on the transform coefficients by using the determined one or more transform kernels.

### (c) Advantageous Effects

As described above, according to an embodiment of the present disclosure, since MTS may be individually applied to intra prediction, inter prediction, ISP, SBT, etc., the efficiency of encoding and decoding may be improved.

In addition, according to another embodiment of the present disclosure, since whether to apply low-frequency non-separable transform (LFNST) is quickly determined, compared to the related art method, the problem of delays in encoding and decoding may be solved.

### BRIEF DESCRIPTION OF THE DRAWINGS

FIG. 1 is a block diagram of a video encoding apparatus capable of implementing the techniques of the present disclosure.

FIG. 2 shows a block partitioning structure using a QuadTree plus BinaryTree TernaryTree (QTBTTT) structure.

FIG. 3A shows a plurality of intra-prediction modes.

FIG. 3B shows a plurality of intra prediction modes including wide-angle intra prediction modes.

FIG. 4 is a block diagram of a video decoding apparatus capable of implementing the techniques of the present disclosure.

FIG. 5 is a flowchart illustrating an example of the present disclosure for controlling multiple transform selection (MTS) at a higher level.

FIGS. 6-10 are flowcharts illustrating various examples of the present disclosure for controlling MTS at a higher level.

### DESCRIPTION OF EMBODIMENTS

Hereinafter, some embodiments of the present disclosure are described in detail with reference to the accompanying drawings. It should be noted that, in adding reference numerals to the constituent elements in the respective drawings, like reference numerals designate like elements, although the elements are shown in different drawings. Further, in the following description of the present disclosure, a detailed description of known functions and configurations incorporated herein has been omitted to avoid obscuring the subject matter of the present disclosure. When a component, device, element, or the like of the present disclosure is described as having a purpose or performing an operation, function, or the like, the component, device, or element should be considered herein as being “configured to” meet that purpose or to perform that operation or function.

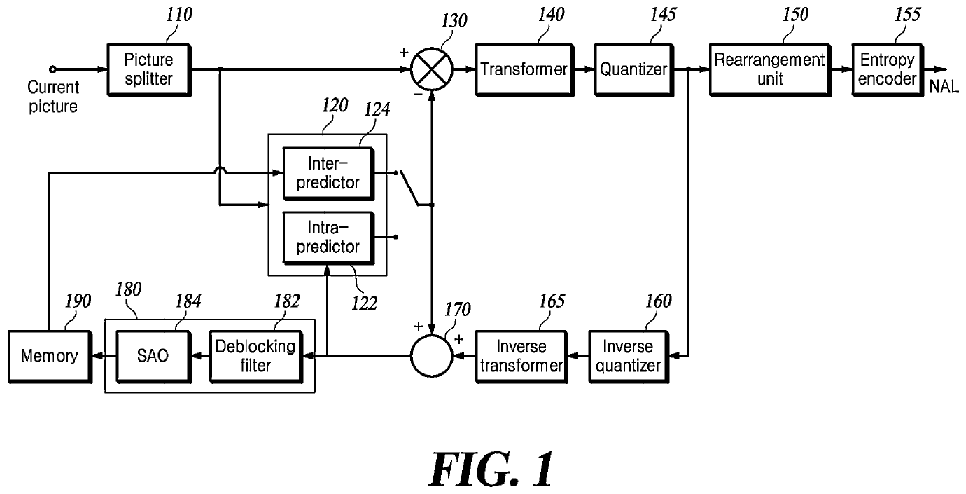

FIG. 1 is a block diagram of a video encoding apparatus capable of implementing the techniques of the present disclosure. Hereinafter, a video encoding apparatus and elements of the apparatus are described with reference to FIG. 1.

The video encoding apparatus includes a picture splitter 110, a predictor 120, a subtractor 130, a transformer 140, a quantizer 145, a rearrangement unit 150, an entropy encoder 155, an inverse quantizer 160, an inverse transformer 165, an adder 170, a filter unit 180, and a memory 190.

Each element of the video encoding apparatus may be implemented in hardware or software, or a combination of hardware and software. The functions of the respective elements may be implemented as software, and a microprocessor may be implemented to execute the software functions corresponding to the respective elements.

One video includes a plurality of pictures. Each picture is split into a plurality of regions, and encoding is performed on each region. For example, one picture is split into one or more tiles or/and slices. Here, the one or more tiles may be defined as a tile group. Each tile or slice is split into one or more coding tree units (CTUs). Each CTU is split into one or more coding units (CUs) by a tree structure. Information applied to each CU is encoded as a syntax of the CU, and information applied to CUs included in one CTU in common is encoded as a syntax of the CTU. In addition, information applied to all blocks in one slice in common is encoded as a syntax of a slice header, and information applied to all blocks constituting a picture is encoded in a picture parameter set (PPS) or a picture header. Furthermore, information, which a plurality of pictures refers to in common, is encoded in a sequence parameter set (SPS). In addition, information referred to by one or more SPSs in common is encoded in a video parameter set (VPS). Information applied to one tile or tile group in common may be encoded as a syntax of a tile or tile group header.

The picture splitter 110 is configured to determine the size of a coding tree unit (CTU). Information about the size of the CTU (CTU size) is encoded as a syntax of the SPS or PPS and is transmitted to the video decoding apparatus.

The picture splitter 110 is configured to split each picture constituting the video into a plurality of CTUs having a predetermined size and then recursively split the CTUs using a tree structure. In the tree structure, a leaf node serves as a coding unit (CU), which is a basic unit of coding.

The tree structure may be a QuadTree (QT), in which a node (or parent node) is split into four sub-nodes (or child nodes) of the same size. The tree structure may also be a BinaryTree (BT), in which a node is split into two sub-nodes. The tree structure may also be a TernaryTree (TT), in which a node is split into three sub-nodes at a ratio of 1:2:1. The tree structure may also be a structure formed by a combination of two or more of the QT structure, the BT structure, and the TT structure. For example, a QuadTree plus BinaryTree (QTBT) structure may be used or a QuadTree plus BinaryTree TernaryTree (QTBTTT) structure may be used. Here, BTTT may be collectively referred to as a multiple-type tree (MTT).

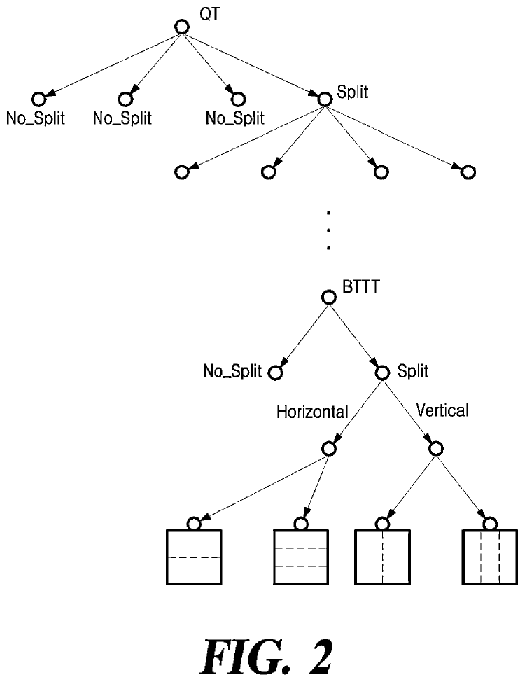

FIG. 2 shows a QTBTTT splitting tree structure. As shown in FIG. 2, a CTU may be initially split in the QT structure. The QT splitting may be repeated until the size of the splitting block reaches the minimum block size MinQTSize of a leaf node allowed in the QT. A first flag (QT_split_flag) indicating whether each node of the QT structure is split into four nodes of a lower layer is encoded by the entropy encoder 155 and signaled to the video decoding apparatus.

When the leaf node of the QT is not larger than the maximum block size (MaxBTSize) of the root node allowed in the BT, it may be further split into one or more of the BT structure or the TT structure. The BT structure and/or the TT structure may have a plurality of splitting directions. For example, there may be two directions, namely, a direction in which a block of a node is horizontally split and a direction in which the block is vertically split. As shown in FIG. 2, when MTT splitting is started, a second flag (mtt_split_flag) indicating whether nodes are split, a flag indicating a splitting direction (vertical or horizontal) in the case of splitting, and/or a flag indicating a splitting type (Binary or Ternary) are encoded by the entropy encoder 155 and signaled to the video decoding apparatus. Alternatively, prior to encoding the first flag (QT_split_flag) indicating whether each node is split into 4 nodes of a lower layer, a CU splitting flag (split_cu_flag) indicating whether the node is split may be encoded. When the value of the CU split flag (split_cu_flag) indicates that splitting is not performed, the block of the node becomes a leaf node in the splitting tree structure and serves a coding unit (CU), which is a basic unit of encoding. When the value of the CU split flag (split_cu_flag) indicates that splitting is performed, the video encoding apparatus starts encoding the flags in the manner described above, starting with the first flag.

When QTBT is used as another example of a tree structure, there may be two splitting types, which are a type of horizontally splitting a block into two blocks of the same size (i.e., symmetric horizontal splitting) and a type of vertically splitting a block into two blocks of the same size (i.e., symmetric vertical splitting). A split flag (split_flag) indicating whether each node of the BT structure is split into block of a lower layer and splitting type information indicating the splitting type are encoded by the entropy encoder 155 and transmitted to the video decoding apparatus. There may be an additional type of splitting a block of a node into two asymmetric blocks. The asymmetric splitting type may include a type of splitting a block into two rectangular blocks at a size ratio of 1:3 or may include a type of diagonally splitting a block of a node.

CUs may have various sizes according to QTBT or QTBTTT splitting of a CTU. Hereinafter, a block corresponding to a CU (i.e., a leaf node of QTBTTT) to be encoded or decoded is referred to as a “current block.” As QTBTTT splitting is employed, the shape of the current block may be square or rectangular.

The predictor 120 is configured to predict the current block to generate a prediction block. The predictor 120 includes an intra-predictor 122 and an inter-predictor 124.

In general, each of the current blocks in a picture may be predictively coded. In general, prediction of a current block is performed using an intra-prediction technique (using data from a picture containing the current block) or an inter-prediction technique (using data from a picture coded before a picture containing the current block). The inter-prediction includes both unidirectional prediction and bi-directional prediction.

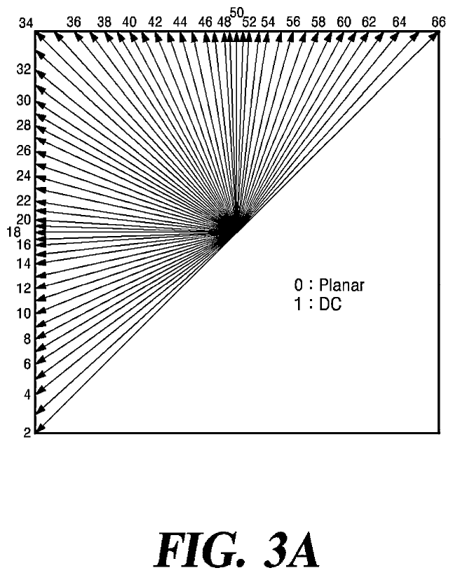

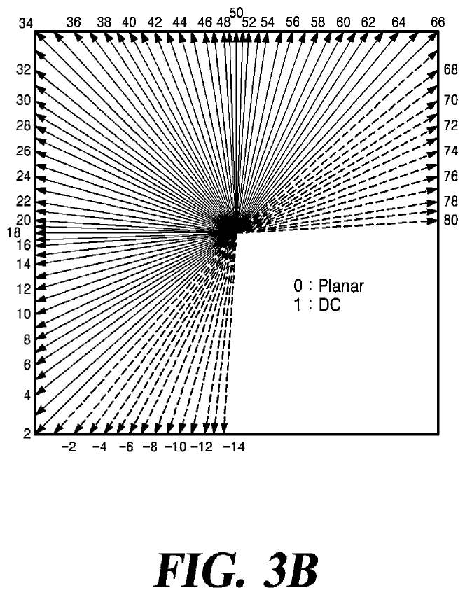

The intra-prediction unit 122 is configured to predict pixels in the current block using pixels (reference pixels) positioned around the current block in the current picture including the current block. There is a plurality of intra-prediction modes according to the prediction directions. For example, as shown in FIG. 3, the plurality of intra-prediction modes may include two non-directional modes, which include a PLANAR mode and a DC mode, and 65 directional modes. Neighboring pixels and an equation to be used are defined differently for each prediction mode.

For efficient directional prediction for a rectangular-shaped current block, directional modes (intra-prediction modes 67 to 80 and −1 to −14) indicated by dotted arrows in FIG. 3B may be additionally used. These modes may be referred to as “wide angle intra-prediction modes.” In FIG. 3B, arrows indicate corresponding reference samples used for prediction, not indicating prediction directions. The prediction direction is opposite to the direction indicated by an arrow. A wide-angle intra prediction mode is a mode in which prediction is performed in a direction opposite to a specific directional mode without additional bit transmission when the current block has a rectangular shape. In this case, among the wide angle intra-prediction modes, some wide angle intra-prediction modes available for the current block may be determined based on a ratio of a width and a height of the rectangular current block. For example, wide angle intra-prediction modes with an angle less than 45 degrees (intra prediction modes 67 to 80) may be used when the current block has a rectangular shape with a height less than the width thereof. Wide angle intra-prediction modes with an angle greater than −135 degrees (intra-prediction modes −1 to −14) may be used when the current block has a rectangular shape with the height greater than the width thereof.

The intra-predictor 122 may determine an intra-prediction mode to be used in encoding the current block. In some examples, the intra-predictor 122 may encode the current block using several intra-prediction modes and select an appropriate intra-prediction mode to use from the tested modes. For example, the intra-predictor 122 may calculate rate distortion values using rate-distortion analysis of several tested intra-prediction modes and may select an intra-prediction mode that has the best rate distortion characteristics among the tested modes.

The intra-predictor 122 is configured to select one intra-prediction mode from among the plurality of intra-prediction modes and predict the current block using neighboring pixels (reference pixels) and an equation determined according to the selected intra-prediction mode. Information about the selected intra-prediction mode is encoded by the entropy encoder 155 and transmitted to the video decoding apparatus.

The inter-predictor 124 is configured to generate a prediction block for the current block through motion compensation. The inter-predictor 124 may search for a block most similar to the current block in a reference picture, which has been encoded and decoded earlier than the current picture and may generate a prediction block for the current block using the searched block. Then, the inter-predictor is configured to generate a motion vector corresponding to a displacement between the current block in the current picture and the prediction block in the reference picture. In general, motion estimation is performed on a luma component, and a motion vector calculated based on the luma component is used for both the luma component and the chroma component. The motion information including information about the reference picture and information about the motion vector used to predict the current block is encoded by the entropy encoder 155 and transmitted to the video decoding apparatus.

The subtractor 130 is configured to subtract the prediction block generated by the intra-predictor 122 or the inter-predictor 124 from the current block to generate a residual block.

The transformer 140 may split the residual block into one or more transform blocks and apply the transformation to the one or more transform blocks. Thus, the residual values of the transform blocks may be transformed from the pixel domain to the frequency domain. In the frequency domain, the transformed blocks are referred to as coefficient blocks containing one or more transform coefficient values. A two-dimensional transform kernel may be used for transformation and one-dimensional transform kernels may be used for horizontal transformation and vertical transformation, respectively. The transform kernels may be based on a discrete cosine transform (DCT), a discrete sine transform (DST), or the like.

The transformer 140 may transform residual signals in the residual block using the entire size of the residual block as a transformation unit. In addition, the transformer 140 may partition the residual block into two sub-blocks in a horizontal or vertical direction and may transform only one of the two sub-blocks. Accordingly, the size of the transform block may be different from the size of the residual block (and thus the size of the prediction block). Non-zero residual sample values may not be present or may be very rare in the untransformed subblock. The residual samples of the untransformed subblock are not signaled and may be inferred as “0” by the video decoding apparatus. There may be multiple partition types according to the partitioning direction and partitioning ratio. The transformer 140 may provide information about the coding mode (or transform mode) of the residual block to the entropy encoder 155. The information about the encoding may include information indicating whether the residual block is transformed or the residual subblock is transformed, information indicating the partition type selected to partition the residual block into subblocks, and information identifying a subblock that is transformed is performed) to the entropy encoder 155. The entropy encoder 155 may encode the information about the coding mode (or transform mode) of the residual block.

The quantizer 145 is configured to quantize transform coefficients output from the transformer 140 and output the quantized transform coefficients to the entropy encoder 155. For some blocks or frames, the quantizer 145 may directly quantize a related residual block without transformation.

The rearrangement unit 150 may reorganize the coefficient values for the quantized residual value. The rearrangement unit 150 may change the 2-dimensional array of coefficients into a 1-dimensional coefficient sequence through coefficient scanning. For example, the rearrangement unit 150 may scan coefficients from a DC coefficient to a coefficient in a high frequency region using a zig-zag scan or a diagonal scan to output a 1-dimensional coefficient sequence. Depending on the size of the transformation unit and the intra-prediction mode, a vertical scan in which a two-dimensional array of coefficients is scanned in a column direction or a horizontal scan in which two-dimensional block-shaped coefficients are scanned in a row direction may be used instead of the zig-zag scan. In other words, a scan mode to be used may be determined among the zig-zag scan, the diagonal scan, the vertical scan, and the horizontal scan according to the size of the transformation unit and the intra-prediction mode.

The entropy encoder 155 is configured to encode the one-dimensional quantized transform coefficients output from the rearrangement unit 150 using various encoding techniques such as Context-based Adaptive Binary Arithmetic Code (CABAC) and exponential Golomb, to generate a bitstream.

The entropy encoder 155 may encode information such as a CTU size, a CU split flag, a QT split flag, an MTT splitting type, and an MTT splitting direction, which are associated with block splitting, such that the video decoding apparatus may split the block in the same manner as in the video encoding apparatus. In addition, the entropy encoder 155 may encode information about a prediction type indicating whether the current block is encoded by intra-prediction or inter-prediction and encode intra-prediction information (i.e., information about an intra-prediction mode) or inter-prediction information (information about a reference picture index and a motion vector) according to the prediction type.

The inverse quantizer 160 is configured to inversely quantize the quantized transform coefficients output from the quantizer 145 to generate transform coefficients. The inverse transformer 165 is configured to transform the transform coefficients output from the inverse quantizer 160 from the frequency domain to the spatial domain and reconstruct the residual block.

The adder 170 is configured to add the reconstructed residual block to the prediction block generated by the predictor 120 to reconstruct the current block. The pixels in the reconstructed current block are used as reference pixels in performing intra-prediction of a next block.

The filter unit 180 is configured to filter the reconstructed pixels to reduce blocking artifacts, ringing artifacts, and blurring artifacts generated due to block-based prediction and transformation/quantization. The filter unit 180 may include a deblocking filter 182 and a pixel adaptive offset (SAO) filter 184.

The deblocking filter 182 is configured to filter the boundary between the reconstructed blocks to remove blocking artifacts caused by block-by-block coding/decoding, and the SAO filter 184 is configured to perform additional filtering on the deblocking-filtered video. The SAO filter 184 is a filter used to compensate for a difference between a reconstructed pixel and an original pixel caused by lossy coding.

The reconstructed blocks filtered through the deblocking filter 182 and the SAO filter 184 are stored in the memory 190. Once all blocks in one picture are reconstructed, the reconstructed picture may be used as a reference picture for inter-prediction of blocks in a picture to be encoded next.

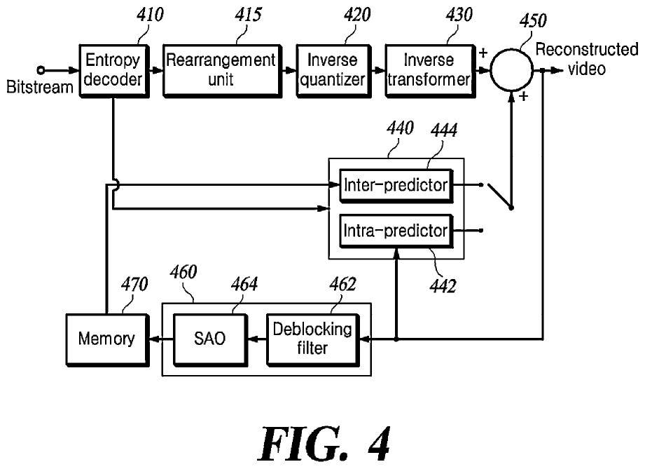

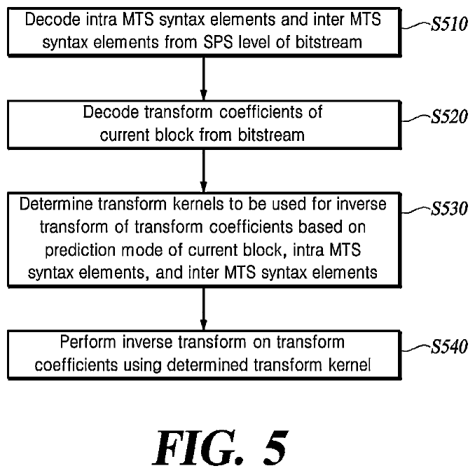

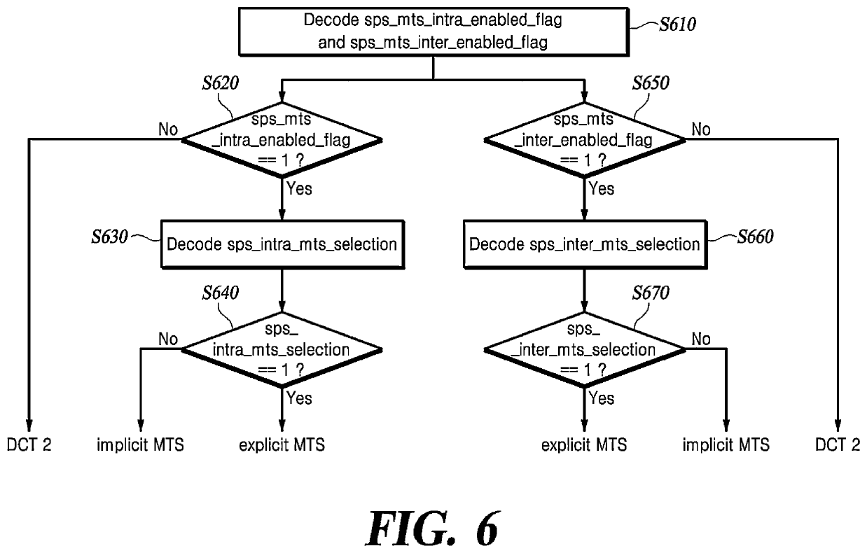

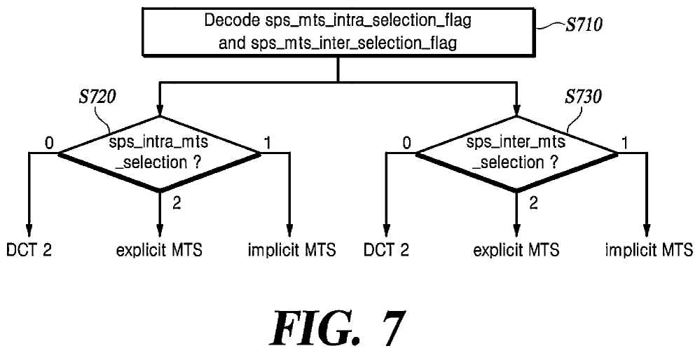

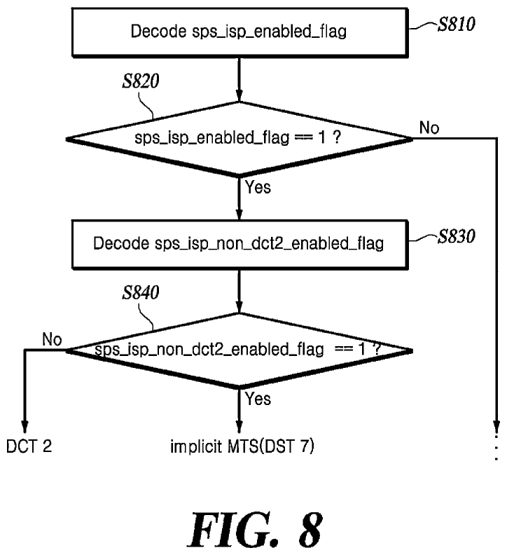

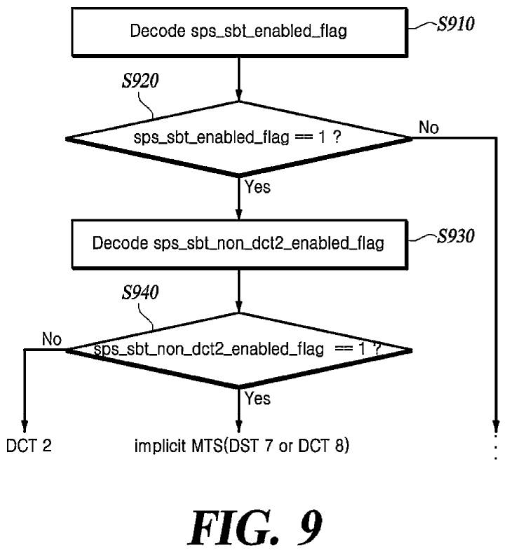

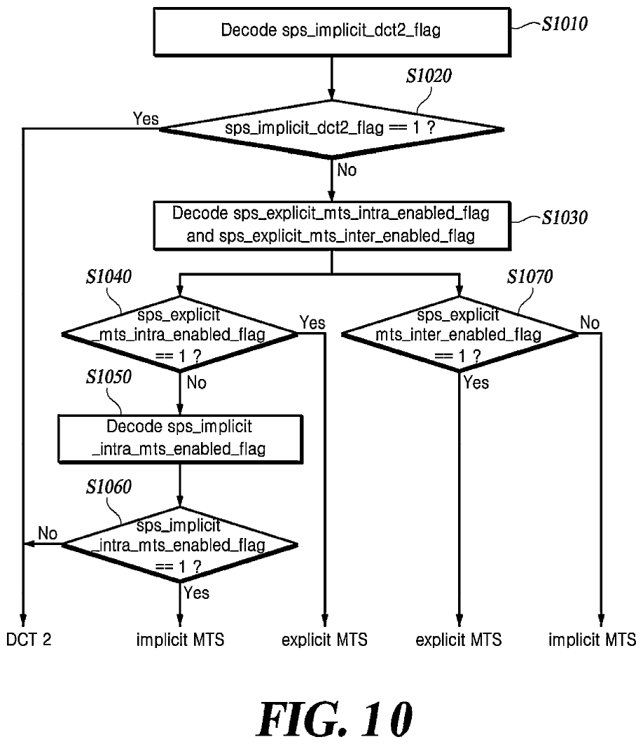

FIG. 4 is a functional block diagram of a video decoding apparatus capable of implementing the techniques of the present disclosure. Hereinafter, the video decoding apparatus and elements of the apparatus are described with reference to FIG. 4.

The video decoding apparatus may include an entropy decoder 410, a rearrangement unit 415, an inverse quantizer 420, an inverse transformer 430, a predictor 440, an adder 450, a filter unit 460, and a memory 470.

Similar to the video encoding apparatus of FIG. 1, each element of the video decoding apparatus may be implemented in hardware, software, or a combination of hardware and software. Further, the function of each element may be implemented in software and the microprocessor may be implemented to execute the function of software corresponding to each element.

The entropy decoder 410 is configured to determine a current block to be decoded by decoding a bitstream generated by the video encoding apparatus and extracting information related to block splitting and configured to extract prediction information and information about a residual signal, and the like required to reconstruct the current block.

The entropy decoder 410 is configured to extract information about the CTU size from the sequence parameter set (SPS) or the picture parameter set (PPS), determine the size of the CTU, and split a picture into CTUs of the determined size. Then, the decoder is configured to determine the CTU as the uppermost layer, i.e., the root node of a tree structure and extract splitting information about the CTU to split the CTU using the tree structure.

For example, when the CTU is split using a QTBTTT structure, a first flag (QT_split_flag) related to splitting of the QT is extracted to split each node into four nodes of a sub-layer. For a node corresponding to the leaf node of the QT, the second flag (MTT_split_flag) and information about a splitting direction (vertical/horizontal) and/or a splitting type (binary/ternary) related to the splitting of the MTT are extracted to split the corresponding leaf node in the MTT structure. Each node below the leaf node of QT is thereby recursively split in a BT or TT structure.

As another example, when a CTU is split using the QTBTTT structure, a CU split flag (split_cu_flag) indicating whether to split a CU may be extracted. When the corresponding block is split, the first flag (QT_split_flag) may be extracted. In the splitting operation, zero or more recursive MTT splitting may occur for each node after zero or more recursive QT splitting. For example, the CTU may directly undergo MTT splitting without the QT splitting, or undergo only QT splitting multiple times.

As another example, when the CTU is split using the QTBT structure, the first flag (QT_split_flag) related to QT splitting is extracted, and each node is split into four nodes of a lower layer. Then, a split flag (split_flag) indicating whether a node corresponding to a leaf node of QT is further split in the BT and the splitting direction information are extracted.

Once the current block to be decoded is determined through splitting in the tree structure, the entropy decoder 410 is configured to extract information about a prediction type indicating whether the current block is intra-predicted or inter-predicted. When the prediction type information indicates intra-prediction, the entropy decoder 410 is configured to extract a syntax element for the intra-prediction information (intra-prediction mode) for the current block. When the prediction type information indicates inter-prediction, the entropy decoder 410 is configured to extract a syntax element for the inter-prediction information, i.e., information indicating a motion vector and a reference picture referred to by the motion vector.

The entropy decoder 410 is configured to extract information about the coding mode of the residual block (e.g., information about whether the residual block is encoded only a subblock of the residual block is encoded, information indicating the partition type selected to partition the residual block into subblocks, information identifying the encoded residual subblock, quantization parameters, etc.) from the bitstream. The entropy decoder 410 also is configured to extract information about quantized transform coefficients of the current block as information about the residual signal.

The rearrangement unit 415 may change the sequence of the one-dimensional quantized transform coefficients entropy-decoded by the entropy decoder 410 to a 2-dimensional coefficient array (i.e., block) in a reverse order of the coefficient scanning performed by the video encoding apparatus.

The inverse quantizer 420 is configured to inversely quantize the quantized transform coefficients. The inverse transformer 430 is configured to inversely transform the inversely quantized transform coefficients from the frequency domain to the spatial domain based on information about the coding mode of the residual block to reconstruct residual signals. A reconstructed residual block for the current block is thereby generated.

When the information about the coding mode of the residual block indicates that the residual block of the current block has been coded by the video encoding apparatus, the inverse transformer 430 uses the size of the current block (and thus the size of the residual block to be reconstructed) as a transform unit for the inverse quantized transform coefficients to perform inverse transform to generate a reconstructed residual block for the current block.

When the information about the coding mode of the residual block indicates that only one subblock of the residual block has been coded by the video encoding apparatus, the inverse transformer 430 uses the size of the transformed subblock as a transform unit for the inverse quantized transform coefficients to perform inverse transform to reconstruct the residual signals for the transformed subblock. The inverse transformer 430 also fills the residual signals for the untransformed subblock with a value of “0” to generate a reconstructed residual block for the current block.

The predictor 440 may include an intra-predictor 442 and an inter-predictor 444. The intra-predictor 442 is activated when the prediction type of the current block is intra-prediction and the inter-predictor 444 is activated when the prediction type of the current block is inter-prediction.

The intra-predictor 442 is configured to determine an intra-prediction mode of the current block among a plurality of intra-prediction modes based on the syntax element for the intra-prediction mode extracted from the entropy decoder 410 and to predict the current block using the reference pixels around the current block according to the intra-prediction mode.

The inter-predictor 444 is configured to determine a motion vector of the current block and a reference picture referred to by the motion vector using the syntax element for the intra-prediction mode extracted from the entropy decoder 410 and to predict the current block based on the motion vector and the reference picture.

The adder 450 is configured to reconstruct the current block by adding the residual block output from the inverse transformer 430 and the prediction block output from the inter-predictor 444 or the intra-predictor 442. The pixels in the reconstructed current block are used as reference pixels in intra-predicting a block to be decoded next.

The filter unit 460 may include a deblocking filter 462 and an SAO filter 464. The deblocking filter 462 is configured to deblock-filter the boundary between the reconstructed blocks to remove blocking artifacts caused by block-by-block decoding. The SAO filter 464 can perform additional filtering on the reconstructed block after deblocking filtering to corresponding offsets so as to compensate for a difference between the reconstructed pixel and the original pixel caused by lossy coding. The reconstructed block filtered through the deblocking filter 462 and the SAO filter 464 is stored in the memory 470. When all blocks in one picture are reconstructed, the reconstructed picture is used as a reference picture for inter-prediction of blocks in a picture to be encoded next.

For efficient video compression, a quantization process or scaling process (hereinafter, referred to as a “scaling process”) may be additionally performed on the residual signals (or residual samples) remaining after prediction through various prediction modes.

Transform of residual samples is a process of converting residual samples from a pixel domain to a frequency domain through a transform technique in consideration of the importance of efficient image compression and visual recognition. Inverse transform of the residual samples is a process of converting the residual samples from the frequency domain to the pixel domain through a transform technique (more exactly, through an inverse transform technique).

However, in the case of a non-natural image such as screen content, the transform/inverse transform technique may be inefficient. Thus, in such a case, the transform/inverse transform technique may be omitted (transform skip). When the transform/inverse transform on the residual samples is omitted, only the scaling process may be performed on the residual samples or only an entropy encoding/decoding process, without scaling, may be performed.

In the case of the encoding/decoding method of the related art, sizes of transform blocks are set to 4×4, 8×8, 16×16, and 32×32, and transform or transform skip may be applied to these transform blocks. When transform is applied to a transform block, the video decoding apparatus may inversely quantize the quantized transform coefficients (TransCoeffLevel[x][y]) and inverse-transform the inversely quantized transform coefficients (d[x][y]) from a frequency domain to a spatial domain to reconstruct residual samples (r[x][y]). Also, the video decoding apparatus may shift the reconstructed residual samples according to a bit depth of a picture to derive shifted residual samples.

In the case of the encoding/decoding method of the related art, transform skip may be applied to a transform block having a size of 4×4, or the transform skip may be applied to a transform block having a different size according to an additional syntax element. When the transform skip is applied to the transform block, the video decoding apparatus may inversely quantize the quantized transform coefficients (TransCoeffLevel[x][y]) and apply a shift operation on the inversely quantized transform coefficients (d[x][y]) to reconstruct the residual samples (r[x][y]). Also, the video decoding apparatus may shift the reconstructed residual samples according to a bit depth of a picture to derive shifted residual samples. Here, the shift operation applied to the inversely quantized transform coefficients is applied instead of a transform technique.

When a flag (e.g., transform_skip_rotation_enabled_flag) indicating whether a rotation technique is applied to the transform skipped residual samples indicates that the rotation technique is applied (i.e., when transform_skip_rotation_enabled_flag is equal to 1), the transform skipped residual samples may be rotated by 180 degrees. Accordingly, the video decoding apparatus may scan the residual samples in the opposite direction or in the opposite order in consideration of symmetry (or rotation).

Multiple Transform Selection (MTS)

When a transform technique is applied to the residual samples, a DCT-II transform kernel (or transform type) is generally applied to the residual samples. However, in order to apply a more appropriate transform technique according to various characteristics of the residual samples, one or two optimal transform kernels, among a plurality of transform kernels, may be selectively applied to the residual samples.

A technique of selecting one or two optimal transform kernels, among multiple transform kernels, and applying the same to residual samples may be referred to as multiple transform selection (MTS).

MTS may reduce a burden on a network by reducing a bit rate for various natural videos such as 4K video, 360-degree video, and drone video. In addition, the MTS may be useful for reducing energy consumption as well as speeding decoding for devices that decode various natural videos.

Transform kernels that may be used for MTS are shown in Table 1.

TABLE 1

| Transform | |
|---|---|
| Type | Basis function Tᵢ(j), i, j = 0, 1, . . . , N − 1 |
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Syntax elements for controlling whether to use MTS may be encoded and signaled from the video encoding apparatus to the video decoding apparatus. MTS control may be performed on a per-block basis (i.e., in a block level) by using a syntax element (mts_cu_flag) that indicates whether MTS is used. However, MTS may also be controlled by using a syntax element (sps_mts_enabled_flag) indicating whether to activate MTS at an SPS level, which is higher than the block level. In this case, mts_cu_flag may be signaled and decoded when MTS is enabled at the SPS level (i.e., sps_mts_enabled_flag is equal to 1). MTS may be applied only to a luma component and may be applied when both a width (a length in a horizontal direction) and a height (a length in a vertical direction) of the current block are 32 or less and the cbf flag is 1.

When MTS is not applied, both a horizontal transform kernel and a vertical transform kernel may be determined as DCT-II transform kernels. In contrast, when MTS is applied, one of explicit MTS and implicit MTS may be applied for inverse transform.

Explicit MTS is a method of explicitly transmitting a transform kernel to be used in a transform block (or transform coefficients). A transform kernel to be used in a transform block is indicated by an index signaled from the video encoding apparatus. In this case, syntax elements (mts_hor_flag and mts_ver_flag) for indicating a transform kernel in a horizontal direction and a transform kernel in a vertical direction may be signaled. Through mts_hor_flag and mts_ver_flag, a transform kernel applied to the horizontal direction and a transform kernel applied to the vertical direction may be selected to be different. A mapping table between mts_cu_flag, mts_hor_flag and mts_ver_flag is shown in Table 2.

TABLE 2

| | | | Intra/Inter | |
|---|---|---|---|---|
| mts_cu_flag | mts_hor_flag | mts_ver_flag | Horizontal | Vertical |
| 0 | | | DCT-II | |
| 1 | 0 | 0 | DST-VII | DST-VII |
| | 0 | 1 | DCT-VIII | DST-VII |
| | 1 | 0 | DST-VII | DCT-VIII |
| | 1 | 1 | DST-VII | DCT-VIII |

As described above, in addition to the explicit MTS for explicitly signaling the transform kernel, implicit MTS for implicitly indicating the transform kernel may be applied.

In the implicit MTS, a transform type pair (trTypeHor and trTypeVer) for indicating a horizontal transform kernel and a vertical transform kernel may be derived through Equation 1 below.

trTypeHor=(nTbW>=4&& nTbW<=16)?DST-VII:DCT-II

trTypeVer=(nTbH>=4&&nTbH<=16)?DST-VII:DCT-II [Equation 1]

In Equation 1, nTbW and nTbH represent a horizontal length (width) and a vertical length (height) of the transform block, respectively.

The transform type pair (trTypeHor and trTypeVer) may be defined as (DST7, DST7), (DST7, DCT2), (DCT2, DST7), and (DCT2, DCT2).

The implicit MTS may be applied when a specific encoding/decoding technique is applied. For example, when the current block is encoded/decoded by intra sub-partition (ISP), DCT-II and DST-VII are applied and when the current block is encoded/decoded by low-frequency non-separable transform (LFNST) and matrix-weighted intra prediction (MIP), MTS is not applied and the transform kernel may be determined as DCT-II.

Meanwhile, in the present disclosure, “a case in which MTS is not applied” refers to a method of determining DCT-II as a transform kernel, without applying explicit MTS and implicit MTS. In addition, “explicit MTS” refers to a method in which the video encoding apparatus signals an index indicating a transform kernel and the video decoding apparatus applies a transform kernel indicated by the signaled index to inverse transform. Furthermore, “implicit MTS” refers to a method in which an index indicating a transform kernel is not signaled from the video encoding apparatus and a transform kernel is derived and used according to a preset condition.

Intra Sub-Partition (ISP)

ISP refers to a technique in which a current block is divided horizontally or vertically into two or four (rectangular) sub-regions depending on a size of the current block and intra prediction is performed for each of the sub-regions. ISP may be applied to a block including a luminance component (i.e., luma intra block).

A minimum size of a block to which ISP may be applied may be 4×8 or 8×4, and if the size of a certain block is the same as the minimum size, the certain block may be divided into two sub-regions. Here, each of the sub-regions may have at least 16 samples. When the size of a certain block exceeds the minimum size, the certain block may be divided into four sub-regions. The same intra prediction mode may be applied to the sub-regions.

A relationship between the ISP and other encoding/decoding techniques is as follows.
Multiple reference line (MRL): If an index of the MRL is not 0 (i.e., when a samples in a line adjacent to a prediction block are not referenced), it is inferred that ISP is not applied, and thus syntax elements related to ISP are not signaled.
Transform coefficient group of entropy coding: When ISP is applied, a subblock of entropy coding has 16 samples in all possible cases as shown in Table 3 below.

TABLE 3

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

CBF coding: when ISP is applied, it may be inferred that at least one of the sub-regions has non-zero CBF. Accordingly, if a total number of sub-regions is n and preceding n−1 sub-regions has zero CBF, the CBF of the last sub-region (n-th sub-region) may be inferred to be non-zero CBF.
MPM: The MPM list may be set such that, except for a DC mode, horizontal intra prediction has priority in the case of ISP horizontal splitting, and vertical intra prediction has priority in the case of ISP vertical splitting.
Transform size restriction: All transform kernels with a length larger than 16 applied to sub-regions in the ISP may be determined as DCT-II.
PDPC: When ISP is applied to a current block, a PDPC filter may not be applied to the sub-regions.
MTS: When ISP is applied to the current block, mts_cu_flag may be implicitly set to 0. Instead, the transform kernel for the ISP may be fixedly selected according to the intra prediction mode and a size of a block. The transform kernel selected for the sub-region having a size of W×h is as follows.

When w is equal to 1 or h is equal to 1, the horizontal transform kernel and the vertical transform kernel may not be set. If w is equal to 2 or w>32, the horizontal transform kernel may be determined as DCT-II. If h is equal to 2 or h>32, the vertical transform kernel may be set to DCT-II. In a case not corresponding to the above examples, transform kernels may be set through Table 4 below.

TABLE 4

| Intra mode | t_{H} | t_{V} |
|---|---|---|
| Planar | DST-VII | DST-VII |
| Ang. 31, 32, 34, 36, 37 | | |
| DC | DCT-II | DCT-II |
| Ang. 33, 35 | | |
| Ang. 2, 4, 6 . . . 28, 30 | DST-VII | DCT-II |
| Ang. 39, 41, 43 . . . 63, 65 | | |
| Ang. 3, 5, 7 . . . 27, 29 | DCT-II | DST-VII |
| Ang. 38, 40, 42 . . . 64, 66 | | |

In Table 4, t_{H} denotes a horizontal transform kernel, and t_{V} denotes a vertical transform kernel.

Sub-Block Transform (SBT)

SBT is a technique in which, for an inter-predicted current block, the corresponding residual block is divided into smaller blocks (subblocks) and only a subblock of the residual block is coded for the current block. SBT type information and SBT position information (specifying the position of the subblocks coded within the residuals block) are signaled from the video encoding apparatus to the video decoding apparatus.

In the case of SBT-V (vertical splitting type), the horizontal length (i.e., width) of the transform block may be equal to ½ or ¼ of the horizontal length (i.e., width) of the current block. In addition, in the case of SBT-H (horizontal splitting type), the vertical length (height) of the transform block may be equal to ½ or ¼. Thus, in SBT, 2:2 splitting, 1:3 splitting, and 3:1 splitting may occur.

Depending on the type of SBT (type information), horizontal transform and vertical transform may be implicitly set to be different. For example, the horizontal transform and vertical transform of position 0 (left subblock) of SBT-V may be DCT-VIII and DST-VII, respectively. If the size of a subblock is greater than 32, both the horizontal transform and the vertical transform may be set to DCT-II.

Low-Frequency Non-Separable Transform (LFNST)

LFNST is a technique for improving the efficiency of encoding and decoding by performing additional transform on transform coefficients transformed through the transform process described above. When the transform process described above is considered as a primary transform, LFNST may correspond to a secondary transform.

LFNST may be applied between a forward primary transform and a quantization process in the video encoding apparatus and may be applied to primary transformed coefficients. In addition, LFNST may be applied between an inverse quantization process and an primary inverse transform in the video decoding apparatus and may be applied to inversely quantized transform coefficients.

In LFNST, a non-separable transform having a size of 4×4 (4×4 LFNST) or a non-separable transform having a size of 8×8 (8×8 LFNST) may be applied depending on the size of a block. For example, the 4×4 LFNST is applied to a small block in which a smaller value of horizontal and vertical sizes of the block is less than 8, and the 8×8 LFNST may be applied to a large block in which a smaller value of horizontal and vertical sizes of the block is greater than 4.

A 4×4 input block X to be applied the 4×4 LFNST may be expressed as a matrix as shown in Equation 2.

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ] \qquad [ Equation 2 ]$$

[symbol] obtained by converting X expressed as a matrix into a vector is expressed in Equation 3 below.

[symbol]

=[X₀₀X₀₁X₀₂X₀₃X₁₀X₁₁. . . X₂₀X₂₁. . . X₃₀X₃₁X₃₂X₃₃]^{T} [Equation 3]

An LFNST transform coefficient vector may be calculated through Equation 4 below. [symbol] denotes an LFNST transform coefficient vector, and T denotes a 16×16 LFNST transform matrix (LFNST transform kernel).

[symbol]

=T· [symbol] [Equation 4]

The 16×1 coefficient vector [symbol] is newly arranged (or re-organized) into a 4×4 block and may be re-organized using a horizontal/vertical/diagonal scan order depending on an intra prediction mode.

In LFNST, there are a total of four transform sets, and two LFNST transform matrices (or transform kernels) for each transform set may be used for LFNST. Among the transform sets, a transform set to be used for LFNST may be determined according to a predefined table that is mapped in a one-to-one (1:1) manner with the intra prediction mode as shown in Table 5 below. For example, when the CCLM mode is used, an index (Tr. set index) indicating a transform set may be set to 0.

TABLE 5

| IntraPredMode | Tr. set index |
|---|---|
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

LFNST may be restricted to be applicable in some cases.

For example, when all coefficients in the remaining sub-groups except for a first coefficient sub-group of the block are 0, LFNST may be applied. Thus, coding of the LFNST index depends on a position of the last non-zero transform coefficient (i.e., last significant coefficient) in a scan order, among the primary transform coefficients.

As another example, LFNST is applicable to an intra-predicted block and is applicable to both a luma block and a chroma block. Accordingly, in the case of a dual tree structure, LFNST indices may also be separately signaled so that the LFNST may be applied separately to the luma block and the chroma block. However, in the case of a P (predictive)/B (bi-predictive) frame, only one LFNST index may be signaled for both the luma block and the chroma block.

As another example, LFNST may be automatically set to not applicable to a block to which ISP is applied, and LFNST may be set to not applicable to a block to which MIP mode is applied.

As another example, in the case of a current block having a large size (e.g., a block exceeding 64×64), it is assumed that the size of the transform block is split, and thus LFNST may not be applied to the large block. In addition, only the DCT-II transform kernel may be set to be applied in LFNST.

In order to improve complexity of LFNST, LFNST may be applied only to a partial region within a block without inspecting the last significant coefficient for the entire block. In this case, a process of inspecting whether the last significant coefficient exists may be applied only to the 4×4 block located at the top left of the block.

For example, in the case of a 4×16 block, since the shorter length, among the horizontal length and the vertical length, is 4 and less than 8, 4×4 LFNST may be applied to the left 4×4 block corresponding to the lowest frequencies. To this end, in Equation 4, transform coefficients of a 4×4 block are rearranged into a 16×1 vector form, a 16×16 LFNST transform kernel T is applied, and LFNST coefficients F are rearranged in a 4×4 form (4×4 block).

As another example, in the case of a 16×16 block, since the shorter length, among the horizontal length and the vertical length, is greater than 8, the top left 48 transform coefficients corresponding to the lowest frequencies are rearranged in the form of a 48×1 vector, then the 16×48 LFNST transform kernel is applied. The LFNST coefficients F are rearranged in a 4×4 form (4×4 blocks).

While LFNST is more effective for transform/inverse transform using DCT-II transform kernel, LFNST may be less effective in some cases, such as implicit MTS, where DCT-II transform kernel is not used. Accordingly, when LFNST or MIP is applied to the current block, a horizontal transform type and a vertical transform type for implicit MTS may be implicitly set as a DCT-II transform kernel.

### Embodiment 1

Embodiment 1 is directed to a method for efficiently controlling MTS.

As described above, in the related art method, sps_mts_enabled_flag specifies whether to enable (use) the MTS at the SPS level. When sps_mts_enabled_flag is equal to 0, MTS is not applied and the DCT-II transform kernel is applied. Meanwhile, when sps_mts_enabled_flag is equal to 1, sps_explicit_mts_intra_enabled_flag and sps_explicit_mts_inter_enabled_flag are signaled and decoded as shown in Table 6 below.

TABLE 6
Descriptor

| | |
|---|---|
| seq_parameter_set_rbsp( ) { | |
| ...... | |
| sps_mts_enabled_flag | u(1) |
| if( sps_mts_enabled_flag ) { | |
| sps_explicit_mts_intra_enabled_flag | u(1) |
| sps_explicit_mts_inter_enabled_flag | u(1) |
| } | |
| ...... | |
| } | |

Whether implicit MTS or explicit MTS is applicable to a block predicted in the intra prediction mode (i.e., intra coding block) and a block predicted in the inter prediction mode (i.e., inter coding block) is determined depending on values of sps_explicit_mts_intra_enabled_flag and sps_explicit_mts_inter_enabled_flag.

sps_explicit_mts_intra_enabled_flag is a syntax element indicating whether the MTS index (mts_idx) is signaled in an intra coding unit syntax. When sps_explicit_mts_intra_enabled_flag is equal to 0, it indicates that implicit MTS is applied for the intra coding block. When sps_explicit_enabled_flag is equal to 1, it indicates that explicit MTS is applied for the intra coding block.

sps_explicit_mts_inter_enabled_flag is a syntax element indicating whether mts_idx is signaled in an inter coding unit syntax. When sps_explicit_mts_inter_enabled_flag is equal to 0, it indicates that implicit MTS is applied for the inter coding block. When sps_explicit_mts_inter_enabled_flag is equal to 1, it indicates that the explicit MTS is applied for the inter coding block.

Table 7 below shows the MTS application method according to the value of sps_mts_enabled_flag, the value of sps_explicit_mts_intra_enabled_flag, and the value of sps_explicit_mts_inter_enabled_flag.

TABLE 7

| Tool | Enabling condition |
|---|---|
| Intra implicit MTS | sps_mts_enabled_flag == 1 |
| | sps_explicit_mts_intra_enabled_flag == 0 |
| Intra explicit MTS | sps_mts_enabled_flag == 1 |
| | sps_explicit_mts_intra_enabled_flag == 1 |
| Inter explicit MTS | sps_mts_enabled_flag == 1 |
| | sps_explicit_mts_inter_enabled_flag == 1 |

However, the above signaling scheme for MTS-related syntax elements may be not efficient to control the MTS. For example, when explicit MTS is used for inter coding blocks, ‘sps_mts_enabled_flag’ having a value of 1 is signaled, not only ‘sps_explicit_mts_inter_enabled_flag’ but also ‘sps_explicit_mts_intra_enabled_flag’ is signaled. Accordingly, it is further required to decode sps_explicit_mts_intra_enabled_flag and evaluate its value, which may degrade the efficiency of the encoding/decoding process.

In addition, when explicit MTS is used for some inter coding blocks and DCT-II transform kernel is to be used for all intra coding blocks, implicit MTS process (sps_explicit_mts_intra_enabled_flag=0) or explicit MTS (sps_explicit_mts_intra_enabled_flag=1) process is performed depending on a value of sps_explicit_mts_intra_enabled_flag. In other words, there arises a problem that the DCT-II transform kernel cannot be fixedly used for the intra coding blocks.

Setting the value of sps_mts_enabled_flag to 0 to prevent MTS from being applied to the intra coding blocks is not an appropriate solution the above problem, because it (MTS disable) also makes the DCT-II transform kernel used for the inter coding blocks.

In addition, as shown in Table 8 below, when the ISP is applied to an intra coding block, the implicit MTS is applied to the intra coding block. When the ISP is not applied to an intra coding block, the implicit MTS or the explicit MTS may be applied to the intra coding block. Accordingly, according to the related art method in which the intra prediction mode and the inter prediction mode cannot be individually controlled, there is also a problem that the application of MTS cannot be individually controlled in relation to other encoding/decoding technologies such as ISP or SBT.

TABLE 8

| MTS applied encoding | | |
|---|---|---|
| technology | Intra Coding Block | Inter Coding Block |
| Implicit MTS | ISP, Nominal intra prediction | SBT |
| Explicit MTS | Nominal Intra prediction | Inter prediction |

Embodiment 1 is directed to solve the problem of the related art method described above by individually controlling the MTS according to the encoding/decoding mode.

First, the video encoding apparatus (or the entropy encoder 155 therein) may encode one or more intra MTS syntax elements and one or more inter MTS syntax elements to signal the encoded syntax elements to the video decoding apparatus. In other words, in the present disclosure, the syntax elements for controlling the MTS for an intra coding block and the syntax elements for controlling the MTS for an inter coding block are separately signaled.

The intra MTS syntax elements are syntax elements controlling the MTS of the intra coding block, and the inter MTS syntax elements are syntax elements controlling the MTS of the inter coding block. Intra MTS syntax elements and inter MTS syntax elements may be defined at the SPS level of a bitstream. In other words, the intra MTS syntax elements and the inter MTS syntax elements may be defined at a level higher than a block level.

The video encoding apparatus (or the entropy encoder 155) may encode (quantized) transform coefficients of the current block and signal the same to the video decoding apparatus.

The video decoding apparatus (or the entropy decoding unit 410 therein) may decode one or more intra MTS syntax elements and one or more inter MTS syntax elements from the SPS level of the bitstream (S510).

The video decoding apparatus (or the entropy decoding unit 410) may decode (quantized) transform coefficients from the bitstream (S520). Also, the video decoding apparatus (or the inverse quantizer 420 therein) may inversely quantize the decoded transform coefficients to derive transform coefficients for the current block.

The video decoding apparatus (or the inverse transformer 430 therein) may determine one or more transform kernels to be used for inverse transform of the derived transform coefficients (S530). The transform kernels to be used for inverse transform may be determined based on a prediction mode (intra prediction mode, inter prediction mode, ISP mode, SBT mode, etc.) of the current block, intra MTS syntax elements, and inter MTS syntax elements.

The video decoding apparatus (or the inverse transformer 430) may inversely transform the transform coefficients using the determined transform kernels to derive a residual block (i.e., residual samples or residual signal) for the current block (S540).

As described above, in Embodiment 1, since syntax elements for controlling the MTS are classified and signaled according to the prediction mode of the current block, the control of the MTS may be implemented separately for each prediction mode of the current block. Accordingly, Embodiment 1 may solve the problem of the related art method in which the MTS for one prediction mode affects the other prediction modes.

Meanwhile, the intra MTS syntax elements and the inter MTS syntax elements may be implemented in various forms. Hereinafter, various types of two syntax elements are described separately according to embodiments.

### Embodiment 1-1

The intra MTS syntax elements may include an intra MTS enable flag (sps_mts_intra_enabled_flag) and an intra MTS selection syntax element (sps_intra_mts_selection). The inter MTS syntax elements may also include an inter MTS enable flag (sps_mts_inter_enabled_flag) and an inter MTS selection syntax element (sps_inter_mts_selection).

sps_mts_intra_enabled_flag corresponds to a syntax element indicating whether MTS of the intra prediction mode is enabled, and sps_mts_inter_enabled_flag corresponds to a syntax element indicating whether MTS of the inter prediction mode is enabled. The video decoding apparatus may decode sps_mts_intra_enabled_flag and sps_mts_inter_enabled_flag from the SPS level of the bitstream (S610).

sps_intra_mts_selection is a syntax element indicating whether mts_idx is included in the bitstream (or whether mts_idx is included in the intra coding unit syntax in the transform unit syntax). Sps_inter_mts_selection is a syntax element indicating whether mts_idx is included in the bitstream (whether mts_idx is included in the inter coding unit syntax in the transform unit syntax). In other words, sps_intra_mts_selection and sps_inter_mts_selection are syntax elements indicating which of an implicit MTS or an explicit MTS is applied.

The video decoding apparatus may evaluate values of sps_mts_intra_enabled_flag and sps_mts_inter_enabled_flag (S620 and S650).

When sps_mts_intra_enabled_flag is equal to 0 (No in S620), the DCT-II transform kernel is applied to all intra coding blocks. Meanwhile, when sps_mts_intra_enabled_flag is equal to 1 (Yes in S620), sps_intra_mts_selection is decoded from the bitstream (S630). When sps_intra_mts_selection is equal to 0 (No in S640), implicit MTS is applied. When sps_intra_mts_selection is equal to 1 (Yes in S640), the transform kernel indicated by mts_idx is applied (i.e., explicit MTS is applied).

When sps_mts_inter_enabled_flag is equal to 0 (No in S650), the DCT-II transform kernel is applied to all inter coding blocks. Meanwhile, when sps_mts_inter_enabled_flag is equal to 1 (Yes in S650), sps_inter_mts_selection is decoded from the bitstream (S660). When sps_inter_mts_selection is equal to 0 (No in S670), implicit MTS is applied. When sps_inter_mts_selection is equal to 1 (Yes in S670), the transform kernel indicated by mts_idx is applied (i.e., explicit MTS is applied).

The syntax structure for Embodiment 1-1 is shown in Table 9.

TABLE 9

```
seq_parameter_set_rbsp( ) {
  sps_mts_intra_enabled_flag
  sps_mts_inter_enabled_flag
  if( sps_mts_intra_enabled_flag ) {
    sps_intra_mts_selection
  }
  if( sps_mts_inter_enabled_flag ) {
    sps_inter_mts_selection
  }
...
}
```

When sps_intra_mts_selection and sps_inter_mts_selection are used, as shown in Table 10 below, the MTS may be separately applied to each of the intra coding block and the inter coding block.

TABLE 10

| MTS applied coding technology | Intra | Inter |
|---|---|---|
| Implicit MTS | ISP, Nominal intra prediction | SBT |
| Explicit MTS | Nominal intra prediction | Inter prediction |

### Embodiment 1-2

The intra MTS syntax elements may be configured to include an intra MTS selection syntax element (sps_intra_mts_selection). The inter MTS syntax elements may also be configured to include an inter MTS selection syntax element (sps_inter_mts_selection).

sps_intra_mts_selection is a syntax element indicating whether MTS of the intra prediction mode is enabled and whether mts_idx is included in the bitstream (whether mtx_idx is included in the intra coding unit syntax in the transform unit syntax). sps_inter_mts_selection is a syntax element indicating whether MTS of the inter prediction mode is enabled and whether the MTS index is included in the bitstream (whether the MTX index is included in the inter coding unit syntax in the transform unit syntax). In other words, sps_intra_mts_selection and sps_inter_mts_selection each is one syntax element indicating whether MTS is enabled and which of an implicit MTS or an explicit MTS is applied.

When sps_intra_mts_selection is equal to a first value (e.g., 0), it may indicate that MTS is not applied for the intra coding block. When sps_intra_mts_selection is equal to a second value (e.g., 1), it may indicate that implicit MTS is applied for the intra coding block. When sps_intra_mts_selection is equal to a third value (e.g., 2), it may indicate that explicit MTS is applied for the intra coding block.

When sps_inter_mts_selection is equal to a first value (e.g., 0), it may indicate that MTS is not applied for the inter-coding block. When sps_inter_mts_selection is equal to a second value (e.g., 1), it may indicate that implicit MTS is applied for the inter-coding block. When sps_inter_mts_selection is equal to a third value (e.g., 2), it may indicate that explicit MTS is applied for the inter coding block.

The video decoding apparatus may decode sps_intra_mts_selection and sps_inter_mts_selection from the SPS level of the bitstream (S710) and determine values of sps_intra_mts_selection and sps_inter_mts_selection (S720, S730).

When sps_intra_mts_selection is equal to 0, the DCT-II transform kernel is applied to all intra coding blocks. When sps_intra_mts_selection is equal to 1, implicit MTS is applied. In other words, when sps_intra_mts_selection is equal to 0 or 1, mts_idx is not signaled and decoded. When sps_intra_mts_selection is equal to 2, a transform kernel indicated by mts_idx is applied (explicit MTS).

When sps_inter_mts_selection is equal to 0, the DCT-II transform kernel is applied to all inter coding blocks. When sps_inter_mts_selection is equal to 1, implicit MTS is applied. That is, when sps_inter_mts_selection is equal to 0 or 1, mts_idx is not signaled and decoded. When sps_inter_mts_selection is equal to 2, a transform kernel indicated by mts_idx is applied (explicit MTS).

A syntax structure for Embodiment 1-2 is shown in Table 11.

TABLE 11
Descriptor

| | |
|---|---|
| seq_parameter_set_rbsp( ) { | |
| ...... | |
| sps_intra_mts_selection | u(1) |
| sps_inter_mts_selection | u(1) |
| if( sps_mts_enabled_flag ) { | |
| ... | |
| } | |

Meanwhile, Embodiments 1-1 and 1-2 may be used interchangeably. For example, intra MTS syntax elements may include sps_mts_intra_enabled_flag and sps_intra_mts_selection as in Embodiment 1-1, and inter MTS syntax elements may be configured to include only sps_inter_mts_selection as in Embodiment 1-2.

As another example, intra MTS syntax elements may be configured to include only sps_intra_mts_selection as in Embodiment 1-2, and inter MTS syntax elements may include sps_mts_inter_enabled_flag and sps_inter_mts_selection as in Embodiment 1-1.

### Embodiment 1-3

Intra MTS syntax elements may include an ISP MTS enable flag (sps_isp_non_dct2_enabled_flag), and inter MTS syntax elements may include an SBT MTS enable flag (sps_sbt_non_dct2_enabled_flag).

sps_isp_non_dct2_enabled_flag is a syntax element indicating whether the DCT-II transform kernel is applied to the intra coding block to which the ISP is applied. sps_isp_non_dct2_enabled_flag may be defined at the SPS level of the bitstream and signaled from the video encoding apparatus to the video decoding apparatus. sps_isp_non_dct2_enabled_flag may be used independently of sps_mts_enabled_flag.

When sps_isp_non_dct2_enabled_flag is equal to 0, it may indicate that the DCT-II transform kernel is applied to the intra coding block to which the ISP is applied. When sps_isp_non_dct2_enabled_flag is equal to 1, it may indicate that the DCT-II transform kernel is not applied to the intra coding block to which the ISP is applied (implicit MTS is applied).

The video decoding apparatus may decode sps_isp_enabled_flag indicating whether the ISP is enabled from the bitstream (S810) and determine a value of sps_isp_enabled_flag (S820).

When sps_isp_enabled_flag is equal to 0 (No in S820), the ISP mode is deactivated, so sps_isp_non_dct2_enabled_flag is not signaled and decoded. Alternatively, when sps_isp_enabled_flag is equal to 1 (Yes in S820), the video decoding apparatus may decode sps_isp_non_dct2_enabled_flag from the bitstream (S830) and determine the value of sps_isp_non_dct2_enabled_flag (S840).

When sps_isp_non_dct2_enabled_flag is equal to 0 (No in S840), the DCT-II transform kernel is applied to the intra coding block to which the ISP may be applied, and when sps_isp_non_dct2_enabled_flag is equal to 1 (Yes in S840), implicit MTS (e.g., DST-VII) may be applied.

sps_sbt_non_dct2_enabled_flag is a syntax element indicating whether a DCT-II transform kernel is applied to an inter-coding block to which SBT is applied. sps_sbt_non_dct2_enabled_flag may be defined at the SPS level of the bitstream and signaled from the video encoding apparatus to the video decoding apparatus. sps_sbt_non_dct2_enabled_flag may be used independently of sps_mts_enabled_flag.

When sps_sbt_non_dct2_enabled_flag is equal to 0, it may indicate that the DCT-II transform kernel is applied to the inter-coding block to which SBT is applied, and when sps_sbt_non_dct2_enabled_flag is equal to 1, it may indicate that the DCT-II transform kernel is not applied (implicit MTS is applied) to the inter-coding block to which SBT is applied.

The video decoding apparatus may decode the sps_sbt_enabled_flag indicating whether SBT is enabled from the bitstream (S910) and determine a value of sps_sbt_enabled_flag (S920).

When sps_sbt_enabled_flag is equal to 0 (No in S920), the SBT mode is deactivated, so sps_sbt_non_dct2_enabled_flag is not signaled and decoded. Alternately, when sps_sbt_enabled_flag is equal to 1 (Yes in S920), the video decoding apparatus may decode sps_sbt_non_dct2_enabled_flag from the bitstream (S930) and determine a value of sps_sbt_non_dct2_enabled_flag (S940).

When sps_sbt_non_dct2_enabled_flag is equal to 0 (No in S940), the DCT-II transform kernel is applied to the inter-coding block to which SBT is applied, and when sps_sbt_non_dct2_enabled_flag is equal to 1 (Yes in S940), implicit MTS (e.g., DST-VII or DCT-VIII) may be applied.

Table 12 shows a syntax structure for Embodiment 1-3.

TABLE 12
Descriptor

| | |
|---|---|
| seq_parameter_set_rbsp( ) { | |
| ... | |
| sps_isp_enabled_flag | u(1) |
| if (sps_isp_enabled_flag) | |
| sps_isp_non_dct2_enabled_flag | u(1) |
| ... | |
| sps_sbt_enabled_flag | u(1) |
| if( sps_sbt_enabled_flag ) { | |
| sps_sbt_max_size_64_flag | u(1) |
| sps_sbt_non_dct2_enabled_flag | u(1) |
| } | |
| ... | |
| } | |

### Embodiment 1-4

In embodiment 1-4, a syntax element (sps_implicit_dct2_flag) indicating whether a DCT-II transform kernel is applied to both the intra coding block and the inter coding block may be further introduced.

The video encoding apparatus may determine whether the DCT-II transform kernel is applied to both the intra-coding block and the inter-coding block and may set a determination result as a value of sps_implicit_dct2_flag. In addition, the video encoding apparatus may encode sps_implicit_dct2_flag to signal the same to the video decoding apparatus.

The video decoding apparatus may decode sps_implicit_dct2_flag from the SPS level of the bitstream (S1010) and determine a value of sps_implicit_dct2_flag (S1020). When sps_implicit_dct2_flag is equal to 1, the DCT-II transform kernel may be applied to both the intra coding block and the inter coding block. Meanwhile, when sps_implicit_dct2_flag is equal to 0 (No in S1010), the video decoding apparatus may decode other syntax elements described below (S1030 and S1050) and may individually control the MTS for each of the intra coding block and the inter coding block according to values of other decoded syntax elements (e.g., intra MTS syntax elements and inter MTS syntax elements).

Other Syntax Elements

Intra MTS syntax elements may include sps_explicit_mts_intra_enabled_flag and sps_implicit_intra_mts_enabled_flag, and inter MTS syntax elements may include sps_explicit_mts_inter_enabled_flag.

Table 13 shows a syntax structure for an example in which intra MTS syntax elements include sps_explicit_mts_intra_enabled_flag and sps_implicit_intra_mts_enabled_flag and inter MTS syntax elements include sps_explicit_mts_inter_enabled_flag.

TABLE 13

| | |
|---|---|
| ... | u(1) |
| sps_implicit_dct2_flag | u(1) |
| if ( sps_implicit_dct2_flag = = 0 ) { | |
| sps_explicit_mts_intra_enabled_flag | u(1) |
| sps_explicit_mts_inter_enabled_flag | u(1) |
| } | |
| if ( sps_explicit_mts_intra_enabled_flag = = 0 ) | |
| sps_implicit_intra_mts_enabled_flag | |
| } | |
| sps_sbt_enabled_flag | u(1) |

sps_explicit_mts_intra_enabled_flag is a syntax element indicating whether explicit MTS is applied to an intra coding block. When sps_explicit_mts_intra_enabled_flag is equal to 0, it may indicate that explicit MTS is not applied, and when sps_explicit_mts_intra_enabled_flag is equal to 1, it may indicate that explicit MTS is applied.

sps_implicit_intra_mts_enabled_flag is a syntax element indicating whether implicit MTS is applied to an intra coding block to which an ISP is not applied. When sps_explicit_mts_intra_enabled_flag is equal to 0 (No in S1040), sps_implicit_intra_mts_enabled_flag may be decoded from the bitstream (S1050). When sps_implicit_intra_mts_enabled_flag is equal to 0 (No in S1060), it may indicate that implicit MTS is not applied (DCT-II transform kernel is applied), and when sps_implicit_intra_mts_enabled_flag is equal to 1 (Yes in S1060), it may indicate that implicit MTS is applied.

sps_explicit_mts_inter_enabled_flag is a syntax element indicating whether explicit MTS is applied to an inter coding block. When sps_explicit_mts_inter_enabled_flag is equal to 0 (No in S1070), it may indicate that explicit MTS is not applied, and when sps_explicit_mts_inter_enabled_flag is equal to 1 (Yes in S1070), it may indicate that explicit MTS is applied.

Intra MTS syntax elements may include an intra MTS selection syntax element (sps_intra_mts_selection), and inter MTS syntax elements may also include an inter MTS selection syntax element (sps_inter_mts_selection).

A method of individually controlling the MTS for an intra coding block and an inter coding block by using sps_intra_mts_selection and sps_inter_mts_selection is the same as that of Embodiment 1-2, and a syntax structure for the corresponding method is shown in Table 14.

TABLE 14

| | |
|---|---|
| ... | u(1) |
| sps_implicit_dct2_flag | u(1) |
| if ( sps_implicit_dct2_flag = = 0 ) { | |
| sps_intra_mts_selection | u(v) |
| sps_inter_mts_selection | u(v) |
| } | |
| ... | |

Intra MTS syntax elements may include an intra MTS enable flag (sps_mts_intra_enabled_flag) and an intra MTS selection syntax element (sps_intra_mts_selection). Inter MTS syntax elements may include an inter MTS enable flag (sps_mts_inter_enabled_flag) and an inter MTS selection syntax element (sps_inter_mts_selection).

A method of individually controlling the MTS for an intra-coding block and an inter-coding block by using sps_mts_intra_enabled_flag, sps_intra_mts_selection, sps_mts_inter_enabled_flag, and sps_inter_mts_selection is the same as that of Embodiment 1-1, and a syntax structure for the corresponding method is shown in Table 15.

TABLE 15

```
seq_parameter_set_rbsp( ) {
  sps_mts_intra_enabled_flag
  sps_mts_inter_enabled_flag
  if( sps_mts_intra_enabled_flag ) {
    sps_intra_mts_selection
  }
  if( sps_mts_inter_enabled_flag ) {
    sps_inter_mts_selection
  }
...
}
```

In the examples of Tables 14 and 15, an ISP MTS enable flag (sps_isp_non_dct2_enabled_flag) may be further included in the intra MTS syntax elements, and an SBT MTS enable flag (sps_sbt_non_dct2_enabled_flag) may be further included in the inter MTS syntax elements.

### Embodiment 2

Embodiment 2 is directed to a method for efficiently controlling LFNST.

### Embodiment 2-1

Whether LFNST is applied is determined by an LFNST index (lfnst_idx) signaled at the block level (CU level) (e.g., defined in the coding unit syntax). A syntax structure in which lfnst_idx is signaled is shown in Table 16.

```
TABLE 16
coding_unit( x0, y0, cbWidth, cbHeight, cqtDepth, treeType,
modeType ) {
  ...
    LfnstDcOnly = 1
    LfnstZeroOutSigCoeffFlag = 1
    transform_tree( x0, y0, cbWidth, cbHeight, treeType )
    lfnstWidth = ( treeType = = DUAL_TREE_CHROMA ) ?
    cbWidth/SubWidthC
          : cbWidth
    lfnstHeight = ( treeType = =
DUAL_TREE_CHROMA ) ? cbHeight / SubHeightC
          : cbHeight
    if( Min( lfnstWidth, lfnstHeight ) >= 4 &&
    sps_lfnst_enabled_flag = = 1
&&
      CuPredMode[ chType ][ x0 ][ y0 ] = = MODE_INTRA &&
      IntraSubPartitionsSplitType = = ISP_NO_SPLIT &&
      ( !intra_mip_flag[ x0 ][ y0 ] ∥
      Min( lfnstWidth, lfnstHeight ) >= 16 ) &&
      tu_mts_idx[ x0 ][ y0 ] = = 0 && Max( cbWidth, cbHeight ) <=
MaxTbSizeY) {
      if( LfnstDcOnly = = 0 && LfnstZeroOutSigCoeffFlag = = 1 )
        lfnst_idx[ x0 ][ y0 ]
    }
  }
```

lfnst_idx may indicate whether to apply LFNST to a coding block and, if applied, which transform kernel in a selected transform set to use. When lfnst_idx is equal to 0, LFNST is not applied to the corresponding coding block. When lfnst_idx is equal to 1, a first transform kernel in a selected transform set is used for LFNST, and when lfnst_idx is equal to 2, a second transform kernel in the selected transform set is used for LFNST. A transform set to be used for LFNST may be selected to be determined as shown in Table 17 depending on an intra prediction direction of a coding block.

TABLE 17

| Intra prediction mode (predModeIntra) | Transform set |
|---|---|
| predModeIntra < 0 | 1 |
| 0 <= predModeIntra <= 1 | 0 |
| 2 <= predModeIntra <= 12 | 1 |
| 13 <= predModeIntra <= 23 | 2 |
| 24 <= predModeIntra <= 44 | 3 |
| 45 <= predModeIntra <= 55 | 2 |
| 56 <= predModeIntra <= 80 | 1 |
| 81 <= predModeIntra <= 83 | 0 |

As shown in Table 16, lfnst_idx is signaled and decoded after a transform_tree syntax. A transform_unit syntax is called within the transform_tree syntax, and a residual_coding syntax is called within this transform_unit syntax. Since a position of the last significant coefficient (lastScanPos) is defined in the residual_coding syntax as shown in Tables 18 and 19, lfnst_idx may be signaled and decoded only after both the transform_tree process and the residual_coding process are completed. Therefore, in the case of the related art method, encoding and decoding delays may occur in the process of determining whether to apply LFNST.

TABLE 18
Descriptor

| | |
|---|---|
| residual_coding( x0, y0, log2TbWidth, log2TbHeight, cIdx ) { | |
| if( ( tu_mts_idx[ x0 ][ y0 ] > 0 \| \| | |
| ( cu_sbt_flag && log2TbWidth < 6 && log2TbHeight < 6 ) ) | |
| && cIdx = = 0 && log2TbWidth > 4 ) | |
| log2ZoTbWidth = 4 | |
| else | |
| log2ZoTbWidth = Min( log2TbWidth, 5 ) | |
| MaxCcbs = 2 * ( 1 << log2TbWidth ) * ( 1<< log2TbHeight ) | |
| if( tu_mts_idx[ x0 ][ y0 ] > 0 \| \| | |
| ( cu_sbt_flag && log2TbWidth < 6 && log2TbHeight < 6 ) ) | |
| && cIdx = = 0 && log2TbHeight> 4 ) | |
| log2ZoTbHeight = 4 | |
| else | |
| log2ZoTbHeight = Min( log2TbHeight, 5 ) | |
| if( log2TbWidth > 0 ) | |
| last_sig_coeff_x_prefix | ae(v) |
| if( log2TbHeight > 0 ) | |
| last_sig_coeff_y_prefix | ae(v) |
| if( last_sig_coeff_x_prefix > 3 ) | |
| last_sig_coeff_x_suffix | ae(v) |
| if( last_sig_coeff_y_prefix > 3 ) | |
| last_sig_coeff_y_suffix | ae(v) |
| log2TbWidth = log2ZoTbWidth | |
| log2TbHeight = log2ZoTbHeight | |
| remBinsPass1 = ( ( 1 << ( log2TbWidth + log2TbHeight ) ) * 7 ) >> 2 | |
| log2SbW = ( Min( log2TbWidth, log2TbHeight ) < 2 ? 1 : 2 ) | |
| log2SbH = log2SbW | |
| if( log2TbWidth + log2TbHeight> 3 ) { | |
| if( log2TbWidth 2 ) { | |
| log2SbW = log2TbWidth | |
| log2SbH = 4 − log2SbW | |
| } else if( log2TbHeight < 2 ) { | |
| log2SbH = log2TbHeight | |
| log2SbW = 4 − log2SbH | |
| } | |
| } | |
| numSbCoeff = 1 << ( log2SbW + log2SbH ) | |
| lastScanPos = numSbCoeff | |

```
TABLE 19
  lastSubBlock =
( 1 << ( log2TbWidth + log2TbHeight − (log2SbW + log2SbH ) ) ) − 1
  do {
    if( lastScanPos = = 0 ) {
      lastScanPos = numSbCoeff
      lastSubBlock− −
    }
    lastScanPos− −
    xS =
DiagScanOrder[ log2TbWidth − log2SbW ][ log2TbHeight − log2SbH ]
        [ lastSubBlock ][ 0 ]
    yS =
DiagScanOrder[ log2TbWidth − log2SbW ][ log2TbHeight − log2SbH ]
        [ lastSubBlock ][ 1 ]
    xC = ( xS << log2SbW ) +
DiagScanOrder[ log2SbW ][ log2SbH ][ lastScanPos ][ 0 ]
    yC = ( yS << 1og2sbH ) +
DiagScanOrder[ log2sbW ][ log2SbH ][ lastScanPos ][ 1 ]
  } while( ( xC != LastSignificantCoeffX ) | | ( yC !=
LastSignificantCoeffY ) )
  if( lastSubBlock = = 0 && log2TbWidth >= 2 &&
log2TbHeight >= 2 &&
    !transform_skip_flag[ x0 ][ y0 ] && lastScanPos > 0 )
    LfnstDcOnly = 0
  if( ( lastSubBlock > 0 && log2TbWidth >= 2 && log2TbHeight >=
2 ) | |
    ( lastScanPos > 7 && ( log2TbWidth = = 2 | | log2TbWidth = =
3 ) &&
    log2TbWidth = = log2TbHeight ) )
    LfnstZeroOutSigCoeffFlag = 0
```

In particular, when the luma block and the chroma block share a tree structure, whether to apply the LFNST may be determined after determining a position (lastScanPos) of the last significant coefficient of the chroma block, so the delay problem may be further aggravated.

To solve this problem, in Embodiment 2-1, a process for signaling and decoding lfnst_idx is moved from a coding_unit syntax (CU level) to a residual_coding syntax (TU level). Specifically, the video encoding apparatus calculates lastScanPos indicating the position of the last significant coefficient, encodes lfnst_idx according to the value of lastScanPos to signal the same to the video decoding apparatus. The video decoding apparatus may calculate lastScanPos and decode lfnst_idx from the bitstream according to the value of lastScanPos.

Accordingly, the processes for signaling and decoding lfnst_idx shown in Table 16 may be deleted from the coding_unit syntax, and may be defined in the residual_coding syntax as shown in Table 20 below.

```
TABLE 20
residual_coding( x0, y0, log2TbWidth, log2TbHeight, cIdx ) {
...
  if( Min( cbWidth, cbHeight ) >= 2 &&
  sps_lfnst_enabled_flag = = 1 &&
    CuPredMode[ chType ][ x0 ][ y0 ] = = MODE_INTRA &&
    IntraSubPartitionsSplitType = = ISP_NO_SPLIT &&
    ( !intra_mip_flag[ x0 ][ y0 ] ∥
    Min( cbWidth, cbHeight ) >= 16 ) &&
    Max( cbWidth, cbHeight ) <= MaxTbSizeY &&
    ( cIdx = = 0 ∥ (treeType = = DUAL_TREE_CHROMA &&
    (cIdx = = 1 ∥
    tu_cbf_cb[ x0 ][ y0 ] = = 0) ) ) {
    if( lastScanPos > 0 && lastScanPos < 16 &&
      !( lastScanPos > 7 && (log2TbWidth = = 2 ∥ log2TbWidth = = 3 )
        && log2TbWidth = = log2TbHeight ) )
      lfnst_idx[ x0 ][ y0 ]
  }
...
```

### Embodiment 2-2

In Embodiment 2-1, the position of the last significant coefficient may be determined only for a luma block, and the result (whether LFNST is applied) may be equally applied to all luma blocks and chroma blocks. This example may be equally applied to a case in which the luma block and the chroma block have different block structures (i.e., dual tree).

As another example, the position of the last significant coefficient may be determined for both the luma block and the chroma block, and whether to apply the determined LFNST using the result may be equally applied to the luma block and the chroma block. This example may also be equally applied to a case in which the luma block and the chroma block have different block structures (i.e., dual tree).

### Embodiment 2-3

According to the related art method, since LFNST and ISP cannot be together applied to one block, lfnst_idx is not signaled and decoded for a block to which ISP is applied. However, Embodiment 2-3 proposes an example in which LFNST and ISP are together applied to one block, by eliminating such a restriction. According to Embodiment 2-3, since the same LFNST is applied to all TUs having a non-zero CBF, lfnst_idx needs to be transmitted only once for all CUs, and thus, bit efficiency may be improved.

Table 21 shows a coding unit syntax that allows ISP and LFNST to be applied together.

```
TABLE 21
  LfnstDcOnly = 1
  LfnstZeroOutSigCoeffFlag = 1
  transform_tree( x0, y0, cbWidth, cbHeight, treeType )
  lfnstWidth = ( treeType = = DUAL_TREE_CHROMA ) ?
  cbWidth/SubWidthC
        : (IntraSubPartitionsSplitType = =
ISP_VER_SPLIT) ? cbWidth/NumIntraSubPartitions : cbWidth
  lfnstHeight = ( treeType = =
DUAL_TREE_CHROMA ) ? cbHeight / SubHeightC
        : ( IntraSubPartitionsSplitType = =
ISP_HOR_SPLIT) ? cbHeight/NumIntraSubPartitions : cbHeight
  if( Min( lfnstWidth, lfnstHeight ) >= 4 &&
  sps_lfnst_enabled_flag = = 1
&&
    CuPredMode[ chType ][ x0 ][ y0 ] = = MODE_INTRA &&
    ( !intra_mip_flag[ x0 ][ y0 ] ∥
    Min( lfnstWidth, lfnstHeight ) >= 16 ) &&
    tu_mts_idx[ x0 ][ y0 ] = = 0 && Max( cbWidth, cbHeight ) <=
MaxTbSizeY) {
    if( ( IntraSubPartitionsSplitType ! =
    ISP_NO_SPLIT ∥ LfnstDcOnly ) = = 0
&& LfnstZeroOutSigCoeffFlag = = 1 )
      lfnst_idx[ x0 ][ y0 ]
  }
```

In this case, the same transform kernel may be applied to all blocks to which ISP is applied by signaling whether LFNST is applied and whether ISP is applied only once at the same level in the bitstream. In other words, since one intra prediction mode is applied to all blocks to which ISP is applied, lfnst_idx may be signaled to use one transform kernel in a transform set determined by the one intra prediction mode.

A minimum size of a block to which the ISP may be applied may be limited to 4×4 according to a minimum size of the LFNST transform kernel. In other words, both the horizontal length and the vertical length of the block may be restricted not to be less than 4.

### Embodiment 2-4

Embodiment 2-4 is directed to a method of combining Embodiments 2-1 and 2-3 to solve the problem of delay in the process for determining whether to apply LFNST, and the method allows LFNST and ISP to be together applied to one block.

In other words, Embodiment 2-4 is directed to a method of moving the process for signaling and decoding lfnst_idx from the coding_unit syntax to the residual_coding syntax and deleting a condition (IntraSubPartitionsSplitType==ISP_NO_SPLIT) indicating that it does not correspond to the ISP in the residual_coding syntax.

A syntax structure for Embodiment 2-4 is shown in Table 22.

```
TABLE 22
residual_coding( x0, y0, log2TbWidth, log2TbHeight, cIdx ) {
...
  if( Min( cbWidth, cbHeight ) >= 2 &&
  sps_lfnst_enabled_flag = = 1 &&
    CuPredMode[ chType ][ x0 ][ y0 ] = = MODE_INTRA &&
    ( !intra_mip_flag[ x0 ][ y0 ] ∥
    Min( cbWidth, cbHeight ) >= 16 ) &&
    Max( cbWidth, cbHeight ) <= MaxTbSizeY &&
    ( cIdx = = 0 ∥ (treeType = =
    DUAL_TREE_CHROMA && (cIdx = = 1 ∥
    tu_cbf_cb[ x0 ][ y0 ] = = 0) ) ) {
    if( lastScanPos > 0 && lastScanPos < 16 &&
      !( lastScanPos > 7 && (log2TbWidth = = 2 ∥ log2TbWidth = = 3 )
        && log2TbWidth = = log2TbHeight ) )
      lfnst_idx[ x0 ][ y0 ]
  }
...
```

According to the embodiment, a syntax (Min(lfnstWidth, lfnstHeight)>=4) for “restricting a minimum size of a block allowed to apply the ISP to 4×4” may be added to the syntax structure of Table 22 below so that, in Embodiment 2-4, the ISP may be applied to blocks of 4×4 or greater, and a result of adding is shown in Table 23.

lfnstWidth=:(IntraSubPartitionsSplitType==ISP_VER_SPLIT)?cbWidth/NumIntraSubPartitions:cbWidth

lfnstHeight=:(IntraSubPartitionsSplitType==ISP_HOR_SPLIT)?cbHeight/NumIntraSubPartitions:cbHeight

```
TABLE 23
residual_coding( x0, y0, log2TbWidth, log2TbHeight, cIdx ) {
...
  if( Min( lfnstWidth, lfnstHeight) >= 4 &&
  sps_lfnst_enabled_flag = = 1
&&
    CuPredMode[ chType ][ x0 ][ y0 ] = = MODE_INTRA &&
    ( !intra_mip_flag[ x0 ][ y0 ] ∥
    Min( cbWidth, cbHeight ) >= 16 ) &&
    Max( cbWidth, cbHeight ) <= MaxTbSizeY &&
    ( cIdx = = 0 ∥ (treeType = = DUAL_TREE_CHROMA &&
    (cIdx = = 1 ∥
    tu_cbf_cb[ x0 ][ y0 ] = = 0) ) ) {
    if( lastScanPos > 0 && lastScanPos < 16 &&
      !( lastScanPos > 7 && (log2TbWidth = = 2 ∥ log2TbWidth = = 3 )
        && log2TbWidth = = log2TbHeight ) )
      lfnst_idx[ x0 ][ y0 ]
```

Although embodiments of the present invention have been described for illustrative purposes, those having ordinary skill in the art should appreciate that and various modifications and changes are possible, without departing from the idea and scope of the invention. Embodiments have been described for the sake of brevity and clarity. Accordingly, one of ordinary skill should understand that the scope of the embodiments is not limited by the embodiments explicitly described above but includes the claims and equivalents thereto.

1. A method for performing inverse transform on transform coefficients of a current block, the method comprising:
decoding one or more intra multiple transform selection (MTS) syntax elements controlling MTS of an intra prediction mode and one or more inter MTS syntax elements controlling MTS of an inter prediction mode from a sequence parameter set (SPS) level of a bitstream;
determining one or more transform kernels to be used for inverse transform of the transform coefficients based on a prediction mode of the current block, the one or more intra MTS syntax elements and the one or more inter MTS syntax elements; and
performing inverse transform on the transform coefficients by using the determined one or more transform kernels.

2. The method of claim 1, wherein the intra MTS syntax elements include:
an intra MTS enable flag indicating whether MTS of the intra prediction mode is enabled; and
an intra MTS selection syntax element indicating whether an MTS index for indicating one or more transform kernels to be used for inverse transform of the transform coefficients is included in the bitstream,
wherein the intra MTS selection syntax element is decoded from the SPS level of the bitstream when it is indicated by the intra MTS enable flag that MTS of the intra prediction mode is enabled.

3. The method of claim 1, wherein the inter MTS syntax elements include:
an inter MTS enable flag indicating whether MTS of the inter prediction mode is enabled; and
an inter MTS selection syntax element indicating whether an MTS index for indicating one or more transform kernels to be used for inverse transform of the transform coefficients is included in the bitstream,
wherein the inter MTS selection syntax element is decoded from the SPS level of the bitstream when it is indicated by the inter MTS enable flag that MTS of the inter prediction mode is enabled.

4. The method of claim 1, wherein the intra MTS syntax elements include an intra MTS selection syntax element indicating one of three different values, and
wherein the intra MTS selection syntax element indicates, by the three different values, whether MTS of the intra prediction mode is enabled and whether an MTS index for indicating one or more transform kernels to be used for inverse transform of the transform coefficients is included in the bitstream when the MTS of the intra prediction mode is enabled.

5. The method of claim 1, wherein the inter MTS syntax elements include an inter MTS selection syntax element indicating three different values, and
wherein the inter MTS selection syntax element indicates, by the three different values, whether MTS of the inter prediction mode is enabled and whether an MTS index for indicating one or more transform kernels to be used for inverse transform of the transform coefficients is included in the bitstream when the MTS of the inter prediction mode is enabled.

6. A decoding apparatus comprising:
a decoder configured to decode one or more intra multiple transform selection (MTS) syntax elements controlling MTS of an intra prediction mode and one or more inter MTS syntax elements controlling MTS of an inter prediction mode from a sequence parameter set (SPS) level of a bitstream; and
an inverse transformer configured to determine one or more transform kernels to be used for inverse transform of the transform coefficients based on a prediction mode of the current block, the one or more intra MTS syntax elements, and the one or more inter MTS syntax elements, and perform inverse transform on the transform coefficients by using the determined one or more transform kernels.

7. The decoding apparatus of claim 6, wherein the intra MTS syntax elements include:
an intra MTS enable flag indicating whether MTS of the intra prediction mode is enabled; and
an intra MTS selection syntax element indicating whether an MTS index for indicating one or more transform kernels to be used for inverse transform of the transform coefficients is included in the bitstream,
wherein the intra MTS selection syntax element is decoded from the SPS level of the bitstream when it is indicated by the intra MTS enable flag that MTS of the intra prediction mode is enabled.

8. The decoding apparatus of claim 6, wherein the inter MTS syntax elements include:
an inter MTS enable flag indicating whether MTS of the inter prediction mode is enabled; and
an inter MTS selection syntax element indicating whether an MTS index for indicating one or more transform kernels to be used for inverse transform of the transform coefficients is included in the bitstream,
wherein the inter MTS selection syntax element is decoded from the SPS level of the bitstream when it is indicated by the inter MTS enable flag that the MTS of the inter prediction mode is enabled.

9. The decoding apparatus of claim 6, wherein the intra MTS syntax elements include an intra MTS selection syntax element indicating one of three different values, and
wherein the intra MTS selection syntax element indicates, by the three different values, whether MTS of the intra prediction mode is enabled and whether an MTS index for indicating one or more transform kernels to be used for inverse transform of the transform coefficients is included in the bitstream when the MTS of the intra prediction mode is enabled.

10. The decoding apparatus of claim 6, wherein the inter MTS syntax elements include an inter MTS selection syntax element indicating one of three different values, and
wherein the inter MTS selection syntax element indicates, by the three different values, whether MTS of the inter prediction mode is enabled and whether an MTS index for indicating one or more transform kernels to be used for inverse transform of the transform coefficients is included in the bitstream when the MTS of the inter prediction mode is enabled.
